(19) United States
(12) Patent Application Publication
(10) Pub. No.: US 2025/0021920 A1
(43) Pub. Date: Jan. 16, 2025

(54) SYSTEMS, APPARATUSES, METHODS, AND COMPUTER PROGRAM PRODUCTS FOR IMPROVED PRODUCT CONDITION MONITORING

(71) Applicant: Honeywell International Inc., Charlotte, NC (US)

(72) Inventors: Kartikeyan Bollapalli, Bengaluru (IN); Srihari Narayanaiah, Bengaluru (IN)

(21) Appl. No.: 18/351,180

(22) Filed: Jul. 12, 2023

(51) Int. Cl. G06Q 50/28

(52) U.S. Cl. CPC G06Q 10/08

(57) ABSTRACT

Embodiments provide for improved product monitoring during transit. Some embodiments receive at least one product identifier associated with at least one product, determine, based at least in part on the at least one product identifier, at least one monitoring parameter, determine a threshold rules set for the at least one product identifier based at least in part on the at least one monitoring parameter, receive monitoring data from one or more monitoring devices configured to monitor the condition of the entirety of an environment within which the at least on product associated with the at least one product identifier is included during transit, process the monitoring data to determine satisfaction of each rule in the threshold rules set for the at least on product identifier, and store at least a portion of the monitoring data corresponding to the at least one monitoring parameter.

### TECHNICAL FIELD

Embodiments of the present disclosure generally provide for improved product condition monitoring during transit, and specifically provide for improved product monitoring during transit using threshold rules.

### BACKGROUND

In various contexts, monitoring products during transportation provides insight into what is happening to the products during transit, for example, to protect and maintain the quality of high value and/or sensitive products (e.g., vaccines, blood, chemicals, etc.) and/or to help ensure adherence to safety and environmental regulations. A transportation may include multiple products of various types with each product type having different quality and safety requirements and/or with each product type requiring different parameters to be monitored during transit to ensure the quality and/or safety of the products when delivered at the final destination.

Applicant has discovered problems and/or other inefficiencies with current implementations of monitoring the condition of products during transit. Through applied effort, ingenuity, and innovation, Applicant has solved many of these identified problems by developing solutions embodied in the present disclosure, which are described in detail below.

### BRIEF SUMMARY

In one aspect, a computer-implemented method for improved product monitoring during transit is provided. The example computer-implemented method includes receiving at least one product identifier associated with at least one product, determining, based at least in part on the at least one product identifier, at least one monitoring parameter, determining a threshold rules set for the at least one product identifier based at least in part on the at least one monitoring parameter, receiving monitoring data from one or more monitoring devices of a plurality of monitoring devices configured to monitor the condition of the entirety of an environment within which the at least on product associated with the at least one product identifier is included during transit, processing the monitoring data to determine satisfaction of each rule in the threshold rules set for the at least on product identifier; and storing at least a portion of the monitoring data corresponding to the at least one monitoring parameter.

The computer-implemented method, where the at least one product identifier comprises a first product identifier associated with a first product and a second product identifier associated with a second product that is different for the first product.

The computer-implemented method, where the at least one monitoring parameter comprises a first parameter of a first sensor type associated with a first product identifier and second parameter of a second sensor type associated with ta second product identifier.

The computer-implemented method, where the at least one monitoring parameter comprises a first monitoring parameter of a first sensor type, wherein the first monitoring parameter is shared between a first product identifier and a second product identifier.

The computer-implemented method, where the one or more monitoring devices comprise at least on IoT device.

The computer-implemented method, where the at least one product identifier is received from an indicia reader configured to read the at least one product identifier from a machine readable symbology associated with the at least one product.

The computer-implemented method, where the one or more monitoring devices are configured to monitor environmental conditions corresponding to the at least one monitoring parameter, and comprise a subset of the plurality of monitoring devices.

The computer-implemented method, further including initiating the operation of the one or more monitoring devices in response to an indication indicating the start of transportation of the at least one product from a starting location to an end location.

The computer-implemented method, where the at least one monitoring parameter comprises one or more of real-time location, temperature, pressure, tilt, altitude, or humidity.

The computer-implemented method, where determining the threshold rules set for the at least one product identifier includes determining threshold data associated with the at least one monitoring parameter, and applying a model to the threshold data to output the threshold rules set.

The computer-implemented method, wherein the threshold data comprises one or more of minimum threshold value for the at least one monitoring parameter, maximum threshold value for the at least one monitoring parameter, or threshold violation duration for the at least one monitoring parameter.

The computer-implemented method, where determining the at least one monitoring parameter comprises retrieving data comprising the at least one monitoring parameter from a master data library.

The computer-implemented method of claim 1, further including generating a notification in response to determining that the monitoring data fails to satisfy at least one rule of the threshold rules set.

In another aspect, an apparatus for improved product monitoring during transit is provided. The example apparatus includes at least one processor and at least one non-transitory memory having computer program code stored thereon that, in execution with the at least one processor, causes the apparatus to perform any one of the example computer-implemented methods described herein.

In another aspect, a computer program product for improved product monitoring during transit is provided. The example computer program product includes at least one non-transitory computer-readable storage medium having computer program code stored thereon that, in execution with at least one processor, configures the computer program product to perform any one of the example computer-implemented methods described herein.

### BRIEF DESCRIPTION OF THE SEVERAL VIEWS OF THE DRAWINGS

Having thus described the embodiments of the disclosure in general terms, reference now will be made to the accompanying drawings, which are not necessarily drawn to scale, and wherein:

FIG. 1 illustrates a block diagram of an example system in which embodiments of the present disclosure may operate.

FIG. 2 illustrates a block diagram of an example apparatus in accordance with at least one example embodiment of the present disclosure.

FIG. 3 illustrates an example data flow diagram for monitoring the condition of product(s) during transit in accordance with at least one example embodiment of the present disclosure.

FIG. 4 illustrates a visualization of example notification renderable in accordance with at least one example embodiment of the present disclosure.

FIG. 5 illustrates a visualization of generating threshold rule sets in accordance with at least one example embodiment of the present disclosure.

FIG. 6 illustrates a flowchart depicting operations of an example process for improved condition monitoring of product(s) during transit in accordance with at least one example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based on in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### Overview

In various contexts where products are transported from a starting location to an end location (e.g., an intermediary or final destination), various entities in the supply chain (e.g., shipping and logistics companies, product manufacturers, regulatory bodies, consumers, etc.) desire and/or require monitoring of the condition of the products during transit to ensure the quality and/or safety of the products and/or to satisfy safety and environmental regulations. Generally, a transportation includes one or more packages housed in a loading space of a transportation vehicle, with each package comprising products of the same type. For example, a given package may comprise one or more products having the same product identifier. Packages may be housed in a loading space in pallet(s). For example, a pallet may comprise one or more packages. Each product type may be sensitive to one or more parameters that can impact the quality and/or safety of the product. Accordingly, a loading space may comprise products with different monitoring requirements. For example, each product type may require different parameters to be monitored to ensure the quality and safety of the respective products. Sensors may be placed on individual products, or individual packages, and/or individual pallets to monitor the condition of the products. However, these generally involve collecting, transferring, and/or storing large amount of data which in turn results in inefficient use of resources (e.g., computing storage space), high network traffic (e.g., from sending and receiving the large amount of data over one or more networks), high computational cost (e.g., from processing the large amount of data), and/or other deficiencies.

Embodiments of the present disclosure provide for improved monitoring of product(s) during transit. Specifically, embodiments of the present disclosure provide for monitoring of product(s) during transit at an environment level and using one or more monitoring devices configured to monitor the entirety of the environment (e.g., load space) that includes the products being transported. Some embodiments determine the parameters to monitor (e.g., “monitoring parameters”) based at least in part on the product identifier(s) associated with each package being transported. Some embodiments determine threshold data for the determined parameters, and generate at least one threshold rules set for each package based at least in part on the determined parameters and corresponding threshold data. Some embodiments receive monitoring data comprising measurement data for the determined parameters for entirety of the environment (e.g., load space) that includes the products being transported. For example, where the determined parameters include temperature and pressure, one or more monitoring devices may be utilized to generate monitoring data that includes the temperature and pressure inside the load space over the duration of the transportation. Some embodiments, apply the threshold rules set(s) to the received monitoring data to determine satisfaction of the threshold rules set(s). Moreover, some embodiments generate and transmit a notification to a user computing device in response to determining violation of a threshold rules set associated with a given package.

In this regard, embodiments of the present disclosure provide various technical advantages and resolve the technical problems identified herein with respect to efficiently and accurately monitoring the condition of product(s) during transit. For example, by monitoring the condition of product(s) during transit based at least in part on monitoring data for the entire environment that includes the product(s), the amount of monitoring data stored is reduced, thus improving computing storage efficiency. Additionally, by monitoring the condition of product(s) during transit based at least in part on monitored data for the entire environment that includes the product(s), the amount of data transmitted between various computing devices over one or more networks is reduced, thus improving network traffic. Additionally, by monitoring the condition of product(s) during transit based at least in part on monitored data for the entire environment that includes the product(s), the amount of monitoring data to be processed is reduced, thus reducing computational cost. Some embodiments monitor particular parameters of an environment based at least in part on products and/or product types specifically determined in that environment to reduce the requirement to transmit and/or store data by enabling storage only of the parameters pertinent to the particular products and/or product types determined in that environment.

### Definitions

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The term “product” refers to any item, article, substance, good, or otherwise any object. A product may be transported from one location to another location via a transportation vehicle. In some examples, one or more products may be sensitive to one or more parameters (e.g., temperature, humidity, and/or the like) at a given level that can impact the quality and or safety of the product. Non-limiting examples of a product include vaccines, food, drugs, equipment, and any other item vulnerable to spoilage based on at least one environmental factor.

The term “product identifier” refers to electronically managed data that uniquely represents a particular product or product type. Non-limiting examples of a product identifier include product name, product code, alphanumeric data, a string, numerical data, or custom object that uniquely represents a particular product or product type. In some embodiments, a product identifier comprises a stock keeping unit (SKU) number.

The term “package” refers to a group of products occupying a defined space. In some examples, a package includes at least one storage container (e.g., cardboard box, plastic container, case, etc.) comprising one or more products. For example, a package may comprise a single storage container including one or more products. As another example, a package may comprise multiple storage containers with each storage container comprising one or more products. In some embodiments, a package comprises product of the same type. In some embodiments, a package is associated the product identifier for the products included in the package. For example, in some embodiments, a package includes a label comprising a machine-readable indicia (e.g., barcode, QR code, and/or the like) that enables determination of the product identifier of products within or otherwise corresponding to the package. In some embodiments, one or more packages are assembled onto a pallet or otherwise define a pallet. In some embodiments, a package is associated with a pallet identifier.

The term “pallet” refers to a collection of one or more packages occupying a defined space. In some embodiments, a package is associated with a pallet identifier.

The term “pallet identifier” refers to electronically managed data that uniquely represents a collection of one or more packages. Non-limiting examples of a pallet identifier include alphanumeric data, a string, numerical data, or custom object that uniquely represents a particular pallet comprising one or more packages. In some embodiments, a pallet identifier comprises a serial shipping container code (SSCC).

The term “load space” refers to any type of environment defining a storage space configured for housing product(s) during transportation. A load space may be associated with a transportation vehicle such as, for example, a parcel van, an airplane, a trailer, a truck, a ship, a human courier or bag associated with the human courier, and/or any other vehicle carrying at least one package. For example, a load space embodying a cargo container may be located on a transportation vehicle during transportation. As another example, a transportation vehicle, such as a van, may include an integrated load space. In some embodiments, a load space may include one or more monitoring devices or otherwise associated with one or more monitoring devices.

The term “monitoring device” refers to any computing device configured to measure one or more parameters. A monitoring device may embody one or more sensors (e.g., temperature sensors, ultrasonic sensors, range sensors, etc.) configured to measure a given parameter. Non-limiting examples of a monitoring device includes a temperature monitoring device, a pressure monitoring device, a humidity monitoring device, and a timer. In some examples, a monitoring comprises an IoT device that communicates measured values over a wireless network, such as the Internet. In some embodiments, a load space comprising products being transported includes one or more monitoring devices configured to output monitoring data representing measurement data for one or more parameters at the load space level (e.g., environment level). For example, a first monitoring device may be configured to measure a first parameter that represents a first condition inside the load space corresponding to the first parameter while a second monitoring device may be configured to measure a second parameter that represents a second condition inside the load space corresponding to the second parameter.

The term “monitoring data” refers to electronically managed data representing output of a monitoring device. Monitoring data comprises measurement values corresponding to one or more parameters (e.g., temperature, pressure, tilt, location, etc.) measured by at least one monitoring device. Non-limiting examples of monitoring data include measurement value(s) representing the temperature inside a load space at a given timestamp over a time period (e.g., transportation duration), measurement value(s) representing the pressure inside a load space at a given time over a time period (e.g., transportation duration), locations of a load space at a particular timestamp over a time period (e.g., transportation duration), altitude of an environment of a load space at a particular timestamp over a time period (e.g., transportation duration), tilt of a load space at a particular timestamp over a time period (e.g., transportation duration), humidity of a load space at a particular timestamp over a time period (e.g., transportation duration), and/or the like.

The term “threshold data” refers to electronically managed data representing a cutoff value, or range of values, that define boundaries of acceptable values for at least one monitored parameter for a particular product identifier (e.g., identifying a particular product or product type). Non-limiting examples of threshold data include minimum threshold value for a given monitoring parameter, maximum threshold value for a given monitoring parameter, violation time threshold value for a given monitoring parameter, and/or the like.

The term “threshold rules set” refers to one or more data structures, formulas, equations, and/or one or more data objects embodying computational logic that enables determination of whether a load space is associated with proper values of monitored parameters for inclusion of one or more products and/or product types in an acceptable condition. In some embodiments, a threshold rules set includes one or more rules defined based at least in part on threshold data associated with a product identifier and corresponding monitoring parameters for the product identifier. An example of a threshold rule is “if monitored temperature is less than 41 degrees fahrenheit or greater than 50 degrees fahrenheit, notify threshold violation for SSCC number (00) 0 0614141 1239876589 0.”

The term “model” refers to one or more algorithmic, statistical, and/or machine learning model(s) that enables generation of output data. For example, in some embodiments a model generates output data comprising threshold rules set for a given product identifier, output data that indicates satisfaction of a threshold rules set or failure to satisfy a threshold rules set, and/or other output data that may be used by a system to facilitate improved monitoring of product(s) during transportation.

The term “master data library” refers to electronically managed data comprising data associated with a plurality of product identifiers. Non-limiting examples of a master data library include data object(s), record(s) in a data repository, or a data structure that includes data associated with a plurality of product identifiers. In some examples a master data library includes data that enables determination of monitoring parameters, threshold data, and/or threshold rules set for a given product identifier. In some embodiments, a master data library includes monitoring parameters and/or threshold data for one or more product identifiers.

### Example Systems and Apparatuses of the Disclosure

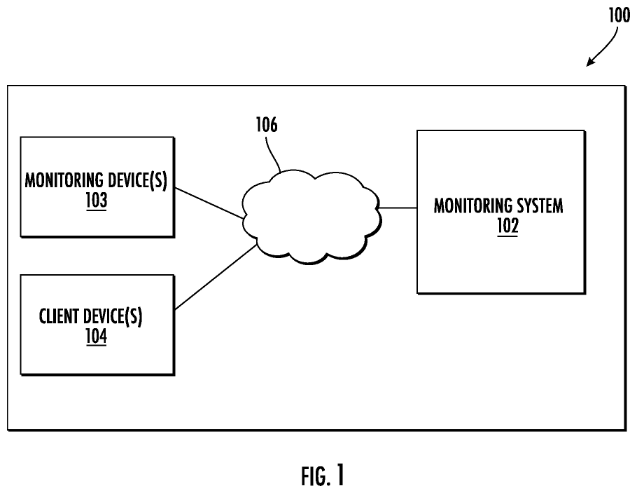

FIG. 1 illustrates a block diagram of an example system within which embodiments of the present disclosure may operate. Specifically, FIG. 1 depicts an example system 100. As illustrated, the system 100 includes one or more monitoring devices 103 and one or more client devices 104 in communication with a monitoring system 102. In some embodiments, the one or more monitoring devices 103 and one or more client devices 104 communicate with the monitoring system 102 over one or more communications network(s), for example a communications network 106.

It should be appreciated that the communications network 106 in some embodiments is embodied in any of a myriad of network configurations. In some embodiments, the communications network 106 embodies a public network (e.g., the Internet). In some embodiments, the communications network 106 embodies a private network (e.g., an internal localized, or closed-off network between particular devices). In some other embodiments, the communications network 106 embodies a hybrid network (e.g., a network enabling internal communications between particular connected devices and external communications with other devices). The communications network 106 in some embodiments includes one or more base station(s), relay(s), router(s), switch(es), cell tower(s), communications cable(s) and/or associated routing station(s), and/or the like. In some embodiments, the communications network 106 includes one or more user controlled computing device(s) (e.g., a user owned router and/or modem) and/or one or more external utility devices (e.g., Internet service provider communication tower(s) and/or other device(s)).

Each of the components of the system 100 communicatively coupled to transmit data to and/or receive data from one another over the same or different wireless and/or wired networks embodying the communications network 106. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network 106, the various embodiments are not limited to this architecture. In other embodiments, one or more computing entities share one or more components, hardware, and/or the like, or otherwise are embodied by a single computing device such that connection(s) between the computing entities over the communications network 106 are altered and/or rendered unnecessary. For example, in some embodiments, the client device 104 includes some or all of the monitoring system 102, such that an external communications network 106 is not required.

In some embodiments, two or more of the monitoring device(s) 103, the client device(s) 104 or the monitoring system 102 are embodied in an on-premises system within or associated with an entity, for example, a logistics and shipping company, a product manufacturer, and/or other entity. In such some embodiments, two or more of the monitoring device(s) 103, the client device(s) 104, or the monitoring system 102 may be communicatively coupled via at least one wired connection. Alternatively or additionally, in some embodiments, the client device 104 embodies or includes the representative monitoring system 102, for example as a software component of a single enterprise terminal.

The monitoring device(s) 103 includes any number of computing device(s), system(s), physical component(s), and/or the like, that facilitates one or more functionalities provided by the monitoring system 102. For example, the monitoring system 102 may leverage the monitoring device(s) 103 to facilitate performance of one or more functionalities provided by the monitoring system 102. In some embodiments, the monitoring device(s) 103 is an enterprise device owned and/or otherwise controlled by an enterprise that similarly owns and/or controls the monitoring system 102. In some embodiments, the monitoring device(s) 103 is a third-party device owned and/or otherwise controlled by another entity, for example, a vendor device, a provider device, a transportation company device, and/or the like. In some embodiments, the monitoring device(s) 103 includes any number of computing device(s), system(s), physical component(s), and/or the like that facilitates and/or performs generation, transferring, and/or receiving of monitoring data of an environment corresponding to a load space including one or more products being transported. In some embodiments, the monitoring data includes measurement data for monitoring parameters associated with one or more product identifiers. In some embodiments, the monitoring device(s) 103 includes computing device(s), system(s), physical component(s), and/or the like embodying one or more sensors configured to measure one or more environmental parameters, for example, temperature, pressure, tilt, altitude, humidity, location and/or other parameters. It will be appreciated that different monitoring device(s) 103 may include different computing device(s), system(s), physical component(s), and/or the like. In some embodiments, the monitoring device(s) 103 are located relative to the load space of a transportation vehicle in a manner that enables the monitoring device(s) 103 to generate monitoring data corresponding to the load space. In one example, at least one monitoring device 103 is located within a load space, for example, fixed to the ceiling and/or other portions of the load space. In some embodiments, each monitoring device of the one or more monitoring device(s) 103 is configured to monitor a particular parameter corresponding to a load space. For example, in such some embodiments, a first monitoring device may be configured to measure a first parameter while a second monitoring device may be configured to measure a second parameter that is different from the first parameter.

The client device(s) 104 includes any number of computing device(s), system(s), physical component(s), and/or the like, that facilitates access (e.g., remote access) to one or more functionalities provided by the monitoring system 102. In some embodiments, the client device(s) 104 is an enterprise device owned and/or otherwise controlled by an enterprise that similarly owns and/or controls the monitoring system 102. In some embodiments, the client device(s) 104 is a third-party device owned and/or otherwise controlled by another entity, for example, a vendor device, a provide device, a transportation company device, and/or the like. In some embodiments, the client device(s) 104 includes any number of computing device(s), system(s), physical component(s), and/or the like that facilitates generation, acquisition, transferring, and/or receiving of data, such as data associated with a product designated for transportation. For example, in some embodiments, at least one client device 104 includes computing device(s), system(s), physical component(s), and/or the like embodying an indicia reader, such as a scanner device configured to read machine-readable symbology (e.g., barcodes, QR codes, and/or other indicia). In some embodiments, the client device(s) 104 includes one or more user device, worker end terminal, smart phone, tablet, personal computer, and/or the like that facilitates access to functionality for transferring data to and/or from the monitoring system 102. In some embodiments, the one or more user device, worker end terminal, smart phone, tablet, personal computer, and/or the like may include an indicia reader. It will be appreciated that different client device(s) 104 may include different computing device(s), system(s), physical component(s), and/or the like.

The monitoring system 102 includes one or more computing device(s) and/or system(s) embodied in hardware, software, firmware, and/or a combination thereof, that performs various functionalities of the monitoring system 102 including monitoring the condition of one or more products during transportation by monitoring the condition of the loading space (e.g., loading space of a transportation vehicle) comprising the one or more products during transit. In some embodiments, the monitoring system 102 includes one or more computing device(s) and/or system(s) embodied in hardware, software, firmware, and/or a combination thereof that generates, measures, transmits, receives, and/or stores data, for example, across one or more communication networks. In some embodiments, the monitoring system 102 includes one or more computing device(s) and/or system(s) embodied in hardware, software, firmware, and/or a combination thereof, that receives product identifiers for product(s) included in a loading space. In some embodiments, the monitoring system 102 includes one or more computing device(s) and/or system(s) embodied in hardware, software, firmware, and/or a combination thereof, that determines monitoring parameters for product(s) being transported based at least in part on a product identifier associated with the product.

In some embodiments, the monitoring system 102 includes one or more computing device(s) and/or system(s) embodied in hardware, software, firmware, and/or a combination thereof, that generates a threshold rules set (e.g., set of one or more rules) for a product identifier associated with a load space monitored by at least one monitoring device 103, for example, based at least in part on the monitoring parameter(s) and threshold data for the product identifier. In some embodiments, the monitoring system 102 includes one or more computing device(s) and/or system(s) embodied in hardware, software, firmware, and/or a combination thereof, that processes monitoring data received from at least one monitoring device 103 to determine satisfaction of the rules set associated with a monitored product. For example, in such some embodiments, the monitoring system 102 may include one or more computing device(s) and/or system(s) embodied in hardware, software, firmware, and/or a combination thereof, that applies the threshold rules set for a given product to at least a portion of the monitored data generated by the one or more monitoring devices 103 to determine satisfaction of the rules set associated with a product identifier associated with at least one product being transported. In some embodiments, the monitoring system 102 includes one or more computing device(s) and/or system(s) embodied in hardware, software, firmware, and/or a combination thereof, that supports a model, where the model may be configured to output data that indicates whether each rule of the threshold rules set associated with a given product identifier is satisfied and/or whether at least one rule of the threshold rules set is not satisfied (e.g., violated). In some embodiments, the monitoring system 102 includes one or more computing device(s) and/or system(s) embodied in hardware, software, firmware, and/or a combination thereof that generates a notification in response to determining that a portion of the monitoring data corresponding to a given product identifier fails to satisfy at least one rule of the threshold rules set for the product identifier. In some embodiments, a determination of a violation of at least one rule of the threshold rules set for a given product identifier is indicative of an unsatisfactory condition of each product in the corresponding load space that is associated with the product identifier.

In some embodiments, the monitoring system 102 includes one or more specially configured application server(s), database server(s), end user device(s), cloud computing system(s), and/or the like. Additionally or alternatively, in some embodiments, the monitoring system 102 includes one or more client devices, and/or the like, that enables access to functionality provided via the monitoring system 102, for example via a web application, native application, and/or the like. In some embodiments, the monitoring system 102 is remotely accessible via one or more communication networks. In some embodiments, the monitoring system 102 and/or client device 104 communicate with one another to perform the various actions described herein. For example, in some embodiments, the monitoring system 102 and the client device 104 communicate to determine product identifiers for a monitored product. Additionally or alternatively, in some embodiments, the monitoring system 102 and the client device 104 communicate to identify threshold data for monitoring parameters associated with a given product identifier.

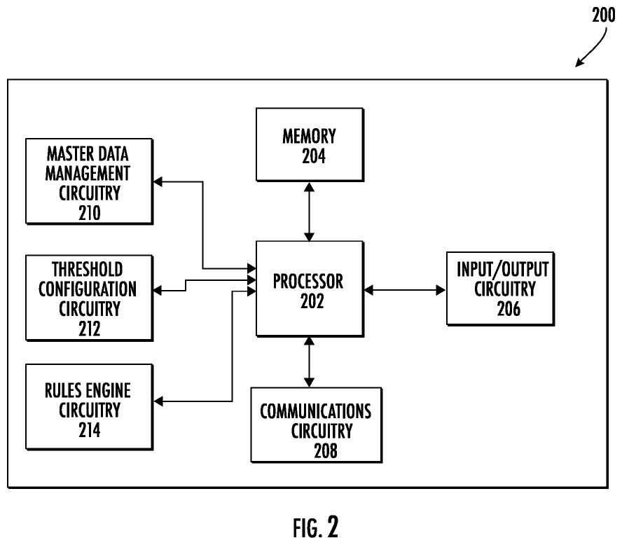

FIG. 2 illustrates a block diagram of an example apparatus in accordance with at least one example embodiment of the present disclosure. Specifically, FIG. 2 depicts an example monitoring apparatus 200 (“apparatus 200”) specially configured in accordance with at least some example embodiments of the present disclosure. In some embodiments, the monitoring system 102 and/or a portion thereof is embodied by one or more system(s), such as the apparatus 200 as depicted and described in FIG. 2. The apparatus 200 includes processor 202, memory 204, input/output circuitry 206, communications circuitry 208, master data management circuitry 210, threshold configuration circuitry 212, and/or rules engine circuitry 214. In some embodiments, the apparatus 200 is configured, using one or more of the sets of circuitry embodied by processor 202, memory 204, input/output circuitry 206, communications circuitry 208, master data management circuitry 210, threshold configuration circuitry 212, and/or rules engine circuitry 214, to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, products/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed.

As one particular example embodiment, the processor 202 is configured to perform various operations associated with monitoring the condition of product(s) during transportation of the product(s). In some embodiments, the processor 202 includes hardware, software, firmware, and/or a combination thereof, that receives product identifier(s) corresponding to one or more products being transported. In such some embodiments, the processor 202 receives product identifiers from a client device, such as client device 104. In some embodiments, the processor 202 includes hardware, software, firmware, and/or a combination thereof, that receives and/or determines monitoring parameter(s) for at least one product based at least in part on product identifier corresponding to the product. In some embodiments, the processor 202 includes hardware, software, firmware, and/or a combination thereof, that receives and/or determines threshold data for each monitoring parameter based at least in part on the product identifier. In some embodiments, the processor 202 includes hardware, software, firmware, and/or a combination thereof, that generates a set of one or more rules for at least one product based at least in part on threshold data for the monitoring parameter(s) associated with the at least one product. In some embodiments, the processor 202 includes hardware, software, firmware, and/or a combination thereof, that processes monitored data received from at least one monitoring device to determine satisfaction of each rule in a rules set associated with a given product (e.g., product identifier thereof). In some embodiments, the processor 202 includes hardware, software, firmware, and/or a combination thereof, that generates a notification in response to determining that at least a portion of the monitoring data fails to satisfy at least one rule of the threshold rules set associated with a given product (e.g., product identifier thereof).

In some embodiments, the apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from user device, one or more asset(s) or accompanying sensor(s), and/or other external computing device in communication with the apparatus 200.

In some embodiments, the apparatus 200 includes master data management circuitry 210. The master data management circuitry 210 includes hardware, software, firmware, and/or a combination thereof, that supports generation, updating, maintenance, and/or use of a master data library. In some embodiments, a master data library includes data associated with a plurality of product identifiers, for example, threshold data, monitoring parameter data, and/or other data that a system may use to generate a threshold rules set for a product identifier and/or that a system may use to monitor the condition of a product during transportation based at least in part on associated product identifier. In some embodiments, the master data management circuitry 210 includes hardware, software, firmware, and/or a combination thereof, that receives data associated with a plurality of product identifiers from one or more data sources. For example, in some embodiments, data associated with a given product identifier may be received from a customer product system. In some embodiments, the master data management circuitry 210 includes hardware, software, firmware, and/or a combination thereof, that updates the master data library in response to receiving data associated with a product identifier, where the received data is not currently stored in the master data library. For example, the master data management circuitry 210 may update the master data library by storing received data in the master data library where the received data is not currently stored in the master data library. Additionally or alternatively, in some embodiments, the master data management circuitry 210 includes hardware, software, firmware, and/or a combination thereof, that updates the master data library in response to receiving data associated with a product identifier, where the received data includes data portions that are different from the existing data in the master data library and/or an indication that the received data includes updated data. The master data management circuitry 210 in some embodiments, for example may include hardware, software, firmware, and/or a combination thereof, that determines whether data stored in the master data library (e.g., threshold data, monitoring parameter data, and/or other data) should be updated. In some embodiments, the master data management circuitry 210 includes a separate processor, specially configured field programmable gate array (FPGA), or a specially programmed application specific integrated circuit (ASIC).

In some embodiments, the apparatus 200 includes threshold configuration circuitry 212. The threshold configuration circuitry 212 includes hardware, software, firmware, and/or a combination thereof, that supports generating, identifying, storing, and/or retrieving a threshold rules set for one or more product identifiers. In some embodiments, the threshold configuration circuitry 212 includes hardware, software, firmware, and/or a combination thereof, that associates a threshold rules set to a given product based at least in part on the product identifier associated with the given product. In some embodiments, the threshold configuration circuitry 212 includes hardware, software, firmware, and/or a combination thereof, that retrieves or receives from a data source (e.g., master data library, client device, and/or other data sources), monitoring parameters and/or threshold data for a given product. In some embodiments, the threshold configuration circuitry 212 includes hardware, software, firmware, and/or a combination thereof, that generates a threshold rules set for a given product identifier associated with a product being transported based at least in part on the monitoring parameters and threshold data for the given product identifier. As described herein, in some embodiments, a threshold rules set for a given product may include one or more rules defined based at least in part on threshold data (e.g., upper limit, lower limit, threshold violation duration, and/or the like) for monitoring parameter(s) associated with a given product identifier. In some embodiments, the threshold configuration circuitry 212 includes hardware, software, firmware, and/or a combination thereof, that supports a model trained, configured, and/or the like to generate a threshold rules set for a product identifier based at least in part on the monitoring parameters and/or threshold data for the product identifier. In some embodiments, the threshold configuration circuitry 212 includes hardware, software, firmware, and/or a combination thereof, that stores and/or retrieves generated threshold rules set in data storage, for example, a master data library. In some embodiments, the threshold configuration circuitry 212 includes a separate processor, specially configured field programmable gate array (FPGA), or a specially programmed application specific integrated circuit (ASIC).

In some embodiments, the apparatus 200 includes rules engine circuitry 214. The rules engine circuitry 214 includes hardware, software, firmware, and/or a combination thereof, that facilitates and/or performs one or more functionalities, including determining violating of a rules set. In some embodiments, the rules engine circuitry 214 includes hardware, software, firmware, and/or a combination thereof, that initiates the operation of the monitoring device(s) configured to monitor a load space comprising the products being transported, or otherwise associated with the load space. In some embodiments, the rules engine circuitry 214 includes hardware, software, firmware, and/or a combination thereof, that initiates the operation of a subset of the monitoring devices, where the subset of monitoring devices include one or more monitoring devices of a plurality of monitoring devices configured to monitor a plurality of parameters corresponding to the load space. In this regard, in some embodiments, the rules engine circuitry 214 includes hardware, software, firmware, and/or a combination thereof, that informs controlling of one or more monitoring devices of a plurality of monitoring devices associated with a loading space, for example, in response to an event, such as the start of transportation. For example, in some embodiments, the rules engine circuitry 214 includes hardware, software, firmware, and/or a combination thereof, that initiates the operation of one or more monitoring devices associated with a load space based at least in part on receiving a signal indicative of the start of transportation. In such some embodiments, the rules engine circuitry 214 initiates or output commands or instructions for controlling the one or more monitoring devices, in a manner that facilitates efficient data storage and reduces network traffic, for example, by transmitting and/or storing monitoring data generated by only a subset of monitoring devices. In some embodiments, the rules engine circuitry 214 communicates with one or more external systems, for example, third party systems to initiate the operation of the monitoring device(s). For example, in some embodiments, the monitoring device(s) associated with a particular load space is controlled by a particular external system, where the monitoring system (e.g., via the rules engine circuitry 214) communicates with the particular external system to initiate the operation of the monitoring devices.

In some embodiments, the rules engine circuitry 214 includes hardware, software, firmware, and/or a combination thereof, that processes monitoring data received from monitoring device(s) to determine satisfaction of each rule in the threshold rules set for a given product (e.g., product identifier thereof). In some embodiments, the rules engine circuitry 214 leverages a model in processing the monitoring data. In such some embodiments, the rules engine circuitry 214 includes hardware, software, firmware, and/or a combination thereof, that supports a model, where the model may be configured to process the monitoring data received from monitoring device(s) to output data that indicates whether each rule of the threshold rules set associated with a product identifier is satisfied or whether at least one rule of the threshold rules set associated with the product identifier is not satisfied (e.g., violated). In some embodiments, the rules engine circuitry 214 includes hardware, software, firmware, and/or a combination thereof, that generates and/or transmits a notification in response to determining that the monitoring data fails to satisfy at least one rule of the threshold rules set for a given product identifier. Additionally or alternatively, in some embodiments, the rules engine circuitry 214 includes hardware, software, firmware, and/or any combination thereof, that causes outputting of a notification in response to determining that monitoring data fails to satisfy at least one rule of the threshold rules set for a given product identifier. In some embodiments, rules engine circuitry 214 includes a separate processor, specially configured field programmable gate array (FPGA), or a specially programmed application specific integrated circuit (ASIC).

Additionally or alternatively, in some embodiments, two or more of the sets of circuitries embodying processor 202, memory 204, input/output circuitry 206, communications circuitry 208, master data management circuitry 210, threshold configuration circuitry 212, and/or rules engine circuitry 214. Alternatively or additionally, in some embodiments, one or more of the sets of circuitry perform some or all of the functionality described associated with another component. For example, in some embodiments, two or more of the sets of circuitry embodied by processor 202, memory 204, input/output circuitry 206, communications circuitry 208, master data management circuitry 210, threshold configuration circuitry 212, and/or rules engine circuitry 214, are combined into a single module embodied in hardware, software, firmware, and/or a combination thereof. Similarly, in some embodiments, one or more of the sets of circuitry, for example master data management circuitry 210, threshold configuration circuitry 212, and/or rules engine circuitry 214, is/are combined with the processor 202, such that the processor 202 performs one or more of the operations described above with respect to each of these sets of circuitry embodied by the master data management circuitry 210, threshold configuration circuitry 212, and/or rules engine circuitry 214.

### Example Data Flows of the Disclosure

Having described example apparatuses and systems in accordance with the disclosure, example data flows in accordance with the disclosure will now be described. The data flow(s) describe generation and/or processing of measurement data associated with one or more products based at least in part on a threshold rules set for each product to facilitate improved monitoring of products during transit. In some embodiments, the data flow includes operations performed by computing system(s) embodying individual system(s), device(s), apparatus(es), and/or the like, and data transmissions between such computing system(s). In some embodiments, the data transmission(s) are facilitated via one or more communications network(s) connecting such computing device(s).

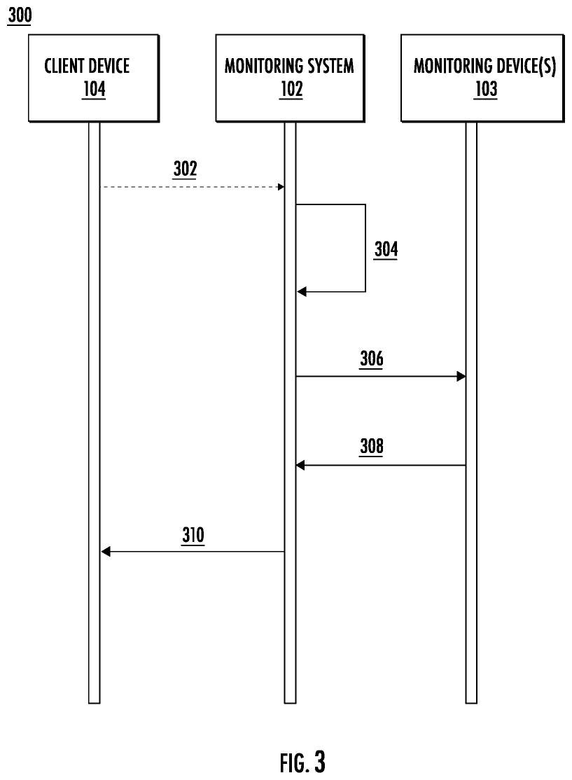

FIG. 3 illustrates an example data flow diagram for monitoring the condition of product(s) during transit in accordance with at least one example embodiment of the present disclosure. Specifically FIG. 3 depicts an example data flow between monitoring system 102, client device 104, and monitoring device(s) 103. The data flow begins optionally at 302. At step 302, monitoring system 102 receives, for each of one or more packages, a product identifier(s) associated with each package based on the products included in the package. For example in some embodiments a package comprises products of the same product type, where each product is associated with the same product identifier. In some embodiments, a package may comprise a plurality of products, where two or more of the products are of different product types and are associated with different product identifiers. In some embodiments, a product identifier refers to any data by which a product or a product type may be uniquely identified from another product or another product type. As illustrated, in some embodiments, the monitoring system 102 receives the product identifier(s) from the client device 104. In some embodiments, the client device 104 includes, embodies, or is otherwise associated with an indicia reader, such as a scanner device where the client device 104 leverages the indicia reader to obtain the product identifier associated with each product. For example, in some embodiments, the client device 104 (e.g., indicia reader thereof), reads an indicia (e.g., machine-readable symbology) associated with each package comprising the product(s) being transported, to obtain data that includes the product identifier for the products included in the respective package. For example, a package may include a label that includes an indicia that enables determination of the product identifiers for the products included in a package. In some embodiments, the monitoring system 102 receives the product identifier(s) from a scanner device that is distinct from the client device 104. In some embodiments, the operation 302 is optional. For example, in some embodiments, the product identifier(s) may have access to the monitoring system by other method(s) that does not include receiving the product identifier(s) from a client device or a scanner device. For example, in some embodiments, the product identifier(s) may be known to the monitoring system 102 through offline or other methods.

At step 304, the monitoring system 102 generates a threshold rules set for each product identifier associated with the products to be monitored (also referred to as “monitored product(s)”) during transportation. In some embodiments, the monitoring system 102 generates a threshold rules set for a given product identifier. Additionally or alternatively, in some embodiments, the monitoring system associates one or more threshold rules sets to a package based at least in part on the product identifiers associated with the package. For example, a package comprising a first product associated with a first product identifier and a second product associated with a second product identifier may be associated with a first threshold rules set generated for the first product identifier as well as a second threshold rules set generated for the second product identifier.

In some embodiments, the monitoring system 102 generates a threshold rules set for a given product identifier based at least in part on monitoring parameters and/or threshold data associated with the product identifier. In this regard, in some embodiments, to generate a threshold rules set for a given product identifier, the monitoring system 102 first determines the monitoring parameter(s) associated with the product identifier. Additionally or alternatively, the monitoring system 102, in some embodiments determines the threshold data (e.g., upper limit, lower limit, threshold violation duration, etc.) for each monitoring parameter(s). In some embodiments, the monitoring system 102 then generates the threshold rules set for the product identifier based at least in part on the monitoring parameter(s) and/or corresponding threshold data. In some embodiments, the monitoring system 102 determines the monitoring parameter(s) and/or corresponding threshold data for a given product identifier by retrieving the monitoring parameter(s) and/or corresponding threshold data from a data source, such as for example, a threshold rules database. In some embodiments, a threshold rules database stores one or more threshold rules set corresponding to one or more product identifiers. In some embodiments, the monitoring parameter(s) for a particular product identifier includes a first parameter of a first sensor type and a second parameter of a second sensor type. For example, the monitoring parameter(s) for a particular product identifier may include a temperature parameter and a humidity parameter. It should be understood, however, that in some embodiments, the monitoring parameter(s) for a particular product identifier may include more than two parameters with different sensor types. In some examples, one or more product identifiers may share the same monitoring parameter. For example, the monitoring parameter(s) for a first product identifier may include a particular parameter, where the monitoring parameter(s) for a second product identifier may also include that same particular parameter. In some examples, the threshold data for product identifiers having the same particular parameter may be the same or may be different.

At step 306, the monitoring system 102 initiates the operation of one or more monitoring devices associated with the load space comprising the product(s) being transported. In some embodiments, the one or more monitoring devices includes one or more sensors and/or components configured to measure one or more parameters (e.g., temperature, pressure, tilt, altitude, humidity, location, etc.) corresponding to the load space. In some embodiments, the one or more parameters comprise at least the monitoring parameters determined for the product identifiers associated with the transportation (e.g., monitoring parameters determined at step 304). In some embodiments, the one or more monitoring devices whose operation is initiated by the monitoring system 102 comprises each monitoring device associated with the load space. For example, in some embodiments, the monitoring system 102 initiates the operation of all monitoring devices associated with the load space. In some embodiments, the one or more monitoring devices whose operation is initiated by the monitoring system 102 includes a subset of the monitoring device(s) associated with the load space, where the subset includes monitoring devices configured to monitor only parameters that correspond to the monitoring parameters for the product identifiers (e.g., monitoring parameters determined at step 304). In some embodiments, initiating the operation of one or more monitoring devices associated with a load space comprise communicating with an external system, for example, third party system associated with the one or more monitoring devices and/or otherwise configured to control the one or more monitoring devices. In some embodiments, each monitoring device of the one or more monitoring device(s) is configured to monitor a particular parameter. For example, in such some embodiments, a first monitoring device may be configured to monitor a first parameter of a plurality of parameters while a second monitoring device may be configured to monitor a second parameter that is different from the first parameter. In some embodiments, the plurality of parameters includes temperature, pressure, tilt, location, humidity, and/or other environmental condition parameters. In some embodiments, the one or more parameters measured by the one or more monitoring devices comprise each parameter measured by the one or more monitoring devices, where the one or more monitoring devices may comprise each monitoring device associated with the load space or a subset of a plurality of monitoring devices associated with the load space.

In some embodiments, the one or more monitoring devices are located relative to the load space in a manner that enables the one or more monitoring devices to monitor the condition of the load space correspond to the monitoring parameters for the products therein. In one example, at least one monitoring device is located within the load space of a transportation vehicle, for example, fixed to the ceiling and/or other portions of the load space.

In some embodiments, the monitoring system 102 initiates the operation of the one or more monitoring devices in response to an event, such as for example, an event indicating that start of transportation of the products from a starting location to a final location. Additionally or embodiments, the monitoring system 102 initiates the operation of the one or more monitoring devices at least in part by communicating with an external system associated with the one or more monitoring devices. In some embodiments, the monitoring system 102 initiates the operation of the one or more monitoring devices at least in part by transmitting control signal(s) to the one or more monitoring devices and/or external system associated with the monitoring devices, where the control signals are configured to cause the one or more monitoring devices to begin capturing monitoring data and/or cause the external system associated with the one or more monitoring devices to initiate operation of the one more monitoring devices.

At step 308, the monitoring system 102 receives monitoring data corresponding to a load space comprising the products being transported. As illustrated the monitoring system receives the monitoring data from the one or more monitoring devices 103. In some embodiments, the one or more monitoring devices is embodied by or otherwise associated with a system (e.g., external system), where the monitoring system 102 receives the measurement data from the system embodying or otherwise associated with the one or more monitoring devices. In some embodiments, the noted system comprises an onboard system associated with the load space or corresponding transportation vehicle. In some embodiments, the monitoring system 102 receives the monitoring data periodically from the one or more monitoring devices 103. In some embodiments, the monitoring system 102 receives the monitoring data in real-time or near real time. In some embodiments, the monitoring system 102 stores the received monitoring data in a database, where the database may be accessed by one or more components of the monitoring system 102, for example, for processing. In some embodiments, the monitoring system 102 stores only a portion of the monitoring data received from the one or more monitoring devices 103. For example, the monitoring system 102 may store only a portion of the received monitoring data that corresponds to the monitoring parameter(s) for product identifiers associated with a load space whose environment is being monitored by the one or more monitoring devices. In this regard, in some embodiments, the monitoring system 102 stores only a portion of the received monitoring data pertinent to the particular products and/or product types determined in the load space environment

At step 310, the monitoring system 102 generates and/or transmits a notification in response to determining that the monitoring data fails to satisfy at least one rule of the threshold rules set. In some embodiments, the notification includes data indicating the monitoring parameter that is violated. Additionally or alternatively, in some embodiments, the notification includes metadata, timestamp data and/or other particular data parameters that are helpful to a system and/or user to determine what actions (e.g., corrective actions to take). It should be appreciated that the notification may be transmitted in any of a myriad of manners utilizing any of a number of communications mechanisms and/or protocol. In some embodiments, the monitoring system 102 transmits the notification as push notification to a client device, and/or other device. Additionally or alternatively, in some embodiments, the monitoring system 102 transmits the notification as a text message to the client device and/or other device. Additionally or alternatively, in some embodiments, the monitoring system 102 transmits the notification as an email or other third-party communication application accessible to the client device or other device. Additionally or alternatively, in some embodiments, the monitoring system 102 stores data to a database indicative of the notification, which is retrieved by the client device and transmitted upon accessing of a particular application (e.g., a user facing application corresponding to accessing the monitoring system 102) at the client device. In some embodiments, the notification is rendered to a screen or other display of the client device. In this regard, a user of the client device (e.g., logistics operator, logistics manager, transportation vehicle operator, product owner, etc.) may view and/or analyze the information associated with the notification to make a determination whether to initiate a corrective action and/or to make a determination regarding the corrective action to initiate.

### Example User Interface of the Disclosure

Having described example apparatuses, systems, and data flows in accordance with the disclosure, example user interface in accordance with the disclosure will now be described. The user interface is generable, displayable, and/or otherwise renderable by one or more of the specially configured computing device(s) as described herein with respect to performance of improved monitoring of product(s) during transit.

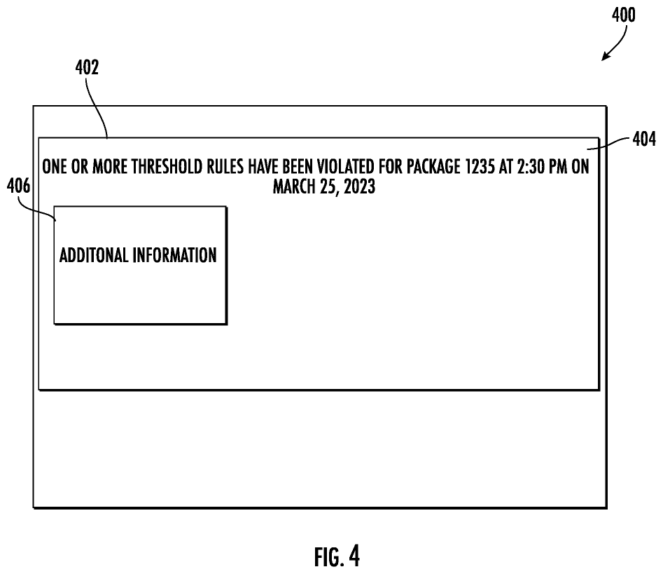

FIG. 4 illustrates a visualization of example notification renderable in accordance with at least one example embodiment of the present disclosure. Specifically, FIG. 4 depicts an example interface 400. In some embodiments, the interface 400 is renderable to a client device. For example, in some embodiments, the interface 400 is rendered in response to the client device receiving one or more notifications, for example, from a monitoring system 102 embodied by the apparatus 200 in response to one or more rule violation determinations (e.g., failure to satisfy at least one rules set associated with a given product identifier). In some embodiments, the interface 400 is rendered on a client device that is the same as the client device that provided the product identifier(s), for example, as described above. In some embodiments, the interface 400 is renderable on a client device that is different from the client device that provided the product identifier(s).

As illustrated, the notification 402 includes a notification description 404. The notification description 404 includes data associated with the rule violation determination. Specifically, notification description 404 embodies a label including a text description indicating several determined data parameter values associated with the rule violation determination. The text description includes, for example, (1) data identifying the package(s) associated with the product identifiers associated with the violation determination (e.g., “Package 1235”), and (2) timestamp data representing the date and time at which the violation occurred. In this regard, a user of the device rendering the interface 400 (e.g., logistics operator, logistics manager, transportation vehicle operator, product owner, etc. associated with a client device to which the interface 400 is rendered) may analyze the detailed data in the notification description 404 to determine further action (e.g., corrective action). Additionally or alternatively, in some embodiments, the text description includes data identifying the pallet associated with the product identifier that is associated with the violation determination. (e.g., one or more threshold rules have been violated for SSCC number (00) 0 0614141 1239876589 0)

In some embodiments, and as illustrated in FIG. 4, the notification 402 further includes one or more interface element(s). For example, the notification 402 includes additional information interface element 406 configured to receive particular user engagement (e.g., a click, tap, or other engagement within the boundaries of the interface element). In some embodiments, a user engagement with the additional information interface element 406 causes additional information regarding the threshold violation to be rendered on the client device. In some embodiments, the additional information includes the particular parameter that was violated, the corresponding measurement data, and/or other data.

### Example Data Architecture of the Disclosure

Having described example apparatuses, systems, data flows, and user interfaces in accordance with the disclosure, visualizations of example environments for monitoring products in accordance with the disclosure will now be describes. In some embodiments, the environment(s) depict data architecture(s) and/or interaction(s) between data within such environment(s) to perform real-time monitoring. In some embodiments, the environment(s) are embodied at least in part by software environment(s) maintained by one or more software application(s) executed via particular hardware and/or firmware of one more computing device(s), for example, the monitoring system 102 embodied by the apparatus 200.

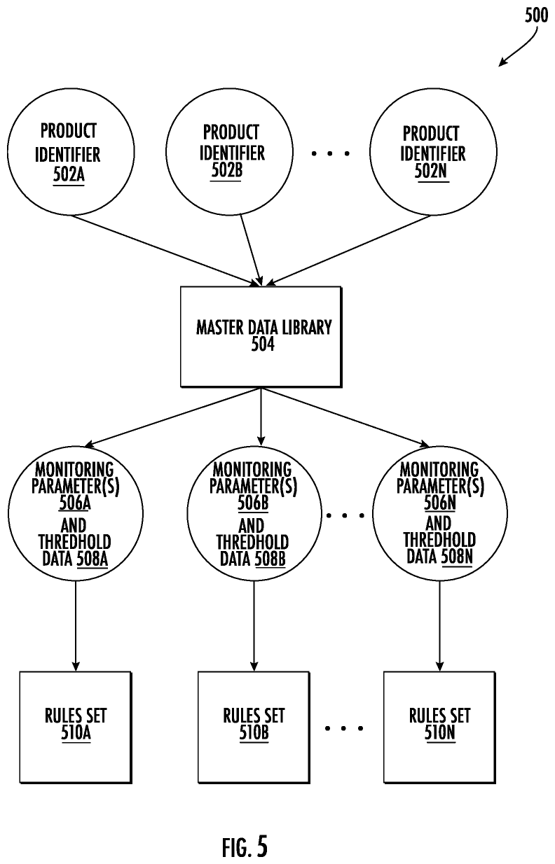

FIG. 5 illustrates a visualization of generating threshold rule sets in accordance with at least one example embodiment of the present disclosure. In some embodiments, one or more product identifiers 502A-502N corresponding to one or more products are received by the apparatus 200. In some embodiments, the one or more product identifiers 502A-502N are received by the apparatus 200 from a client device (e.g., associated with a client system). In some embodiments, receipt of the one or more product identifiers represents a request to initiate a monitoring operation (e.g., real-time monitoring operation). Additionally or alternatively, in some embodiments, the apparatus 200 receives the one or more product identifiers 502A-502N in response to a product monitoring request by a client device. Additionally or alternatively, in some embodiments, the product monitoring requests includes the one or more product identifiers 502A-502N. In some embodiments, the one or more product identifiers 502A-502N are obtained by the client device from a label associated with the packages comprising the one or more products, for example by using an indica reader associated with the client device to read the indicia embodied by the label. In some embodiments, the indicia on a label associated with a package includes the product identifier of the product(s) included in the package.

In some embodiments, the apparatus 200 retrieves monitoring parameter(s) and corresponding threshold data for the monitoring parameter(s) for each product identifier. As illustrated the apparatus 200 may retrieve monitoring parameter(s) 506A and threshold data 508A for product identifier 502A. As further illustrated the apparatus 200 may retrieve monitoring parameter(s) 506B and threshold data 508B for product identifier 502B and so on until monitoring parameter(s) 506N and threshold data 508N are retrieved for product identifier 502N. In some embodiments, the product identifiers 502A-502N represent unique product identifiers associated with the packages(s) stored in the load space. For example, one or more packages may be associated with the same product identifier. In some embodiments, the apparatus 200 retrieves the monitoring parameter(s) 506A-506N and corresponding threshold data 508A-508N from master data library 504. For example, in some embodiments, the master data library 504 includes and maintains monitoring parameter data, threshold data, and/or other data for each of a plurality of product identifiers.

In some embodiments, the apparatus 200 generates a threshold rules set 510A-510N for the product identifiers 502A-502N based at least in part on the monitoring parameter(s) 506A-506N and corresponding threshold data 508A-508N. As illustrated the apparatus 200 may generate threshold rules set 510A for product identifier 502A based at least in part on monitoring parameter(s) 506A and threshold data 508A for product identifier 502A. As further illustrated the apparatus 200 may generate threshold rules set 510B for product identifier 502B based at least in part on monitoring parameter(s) 506B and threshold data 508B for product identifier 502B. As illustrated the apparatus may continue to generate threshold rules set for each product identifier until the apparatus generates threshold rules set 510A based at least in part on monitoring parameter(s) 506N and threshold data 508N for product identifier 502N. In some embodiments, the apparatus 200 leverages a model to generate the threshold rules set 510A-510N.

### Example Processes of the Disclosure

Having described example apparatuses, systems, data flows, user interfaces, and environments in accordance with the disclosure, processes for monitoring conditions of products during transportation in accordance with the disclosure will now be described. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depicts a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

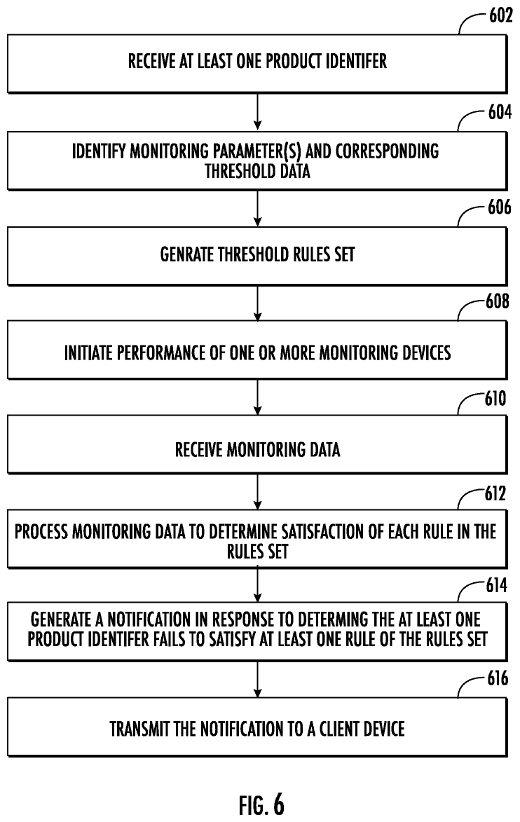

FIG. 6 illustrates a flowchart depicting operations of an example process for improved condition monitoring of product(s) during transit in accordance with at least one example embodiment of the present disclosure. Specifically, FIG. 6 depicts an example process 600. In some embodiments, the process 600 is embodied by computer program code stored on a non-transitory computer-readable storage medium of a computer program product configured for execution to perform the process as depicted and described. Alternatively or additionally, in some embodiments, the process 600 is performed by one or more specially configured computing devices, such as the apparatus 200 alone or in communication with one or more other component(s), device(s), system(s), and/or the like. In this regard, in such some embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with at least one external data repository, client system, and/or the like, to perform one or more of the operation(s) as depicted and described. For purposes of simplifying the description, the process 600 is described as performed by and from the perspective of the apparatus 200.

According to some examples, the method includes receiving at least one product identifier associated with at least one product at operation 602. In some embodiments, each package is associated with a product identifier. In some embodiments, one or more packages are assembled to form a pallet or otherwise define a pallet of packages. In such some embodiments, each pallet may be associated with a pallet identifier. In this regard, in such some embodiments, a product identifier may be associated with a corresponding pallet identifier. In some embodiments, the apparatus 200 receives the at least one product identifier from a client device. In some embodiments, the client device includes, embodies, and/or is associated with an indicia reader, such as a scanner device, where the indicia reader is configured to read the at least one product identifier or data comprising the at least one product identifier from an indicia (e.g., machine-readable symbology) associated with the at least one product. For example, in some embodiments, the apparatus 200 may be configured to extract the at least one product identifier from data received from the client device, In some embodiments, the at least one product identifier comprises a first product identifier associated with a first product and a second product identifier associated with a second product that is different from the first product. For example, the at least one product identifier may comprise a first product identifier associated with a first package comprising one or more products having a first product type, and a second product identifier associated with a second package comprising one or more products have a second product type.

According to some examples, the method includes identifying monitoring parameter(s) and corresponding threshold data for the monitoring parameter(s) for the at least one product identifier at operation 604. In some embodiments, the apparatus 200 identifies the monitoring parameter(s) and corresponding threshold data for the monitoring parameter(s) based at least in part on the product identifier associated with the at least one product. In some embodiments, identifying the monitoring parameter(s) and corresponding threshold data for the monitoring parameter(s) for the at least one product identifier includes retrieving data comprising the monitoring parameter(s) and corresponding threshold data from a data source, for example, a master data library. The data source (e.g., master data library) in some embodiments stores various data associated with a plurality of product identifiers, including, for example, monitoring parameters associated with each product identifier of the plurality of product identifiers, threshold data associated with each monitoring parameter associated with each product identifier. In some embodiments, the apparatus 200 receives the monitoring parameter(s) and/or threshold data associated with the at least one product identifier from the client device In some embodiments, a monitoring parameter comprises an environmental parameter(s) that may be leveraged to determine or otherwise infer the condition of a product associated with the product identifier. In some embodiments, the at least one monitoring parameter comprises one or more of real time location, temperature, pressure, tilt, altitude, or humidity. In some examples, the at least one monitoring parameter includes a particular parameter of a particular sensor type, wherein the particular parameter is shared between a first product identifier and a second product identifier. In some embodiment, the first product identifier is associated with first threshold data and the second product identifier is associated with second threshold data, and wherein the threshold data associated with the environment (e.g., load space) is determined by resolving the first threshold data and the second threshold data.

According to some examples, the method includes generating a threshold rules set for the at least one product identifier based at least in part on the monitoring parameter(s) and corresponding threshold data for the monitoring parameter(s) at operation 606. In some embodiments, a threshold rules set includes one or more rules defined based at least in part on threshold data associated with a product identifier and corresponding monitoring parameters for the product identifier. An example of a threshold rule that may be included in a threshold rules set is “if monitored temperature is less than 41 degrees fahrenheit or greater than 50 degrees fahrenheit, notify threshold violation for SSCC number (00) 0 0614141 1239876589 0.” In some embodiments, the apparatus 200 stores the generated threshold rules set in a threshold rules database, where the generated threshold rules set may be retrieved and applied for subsequent monitoring operation. For example, in some embodiments, the apparatus 200, in response to receiving a product identifier determines if the threshold rules database includes a threshold rules set for the product identifier. In such some embodiments, in response to determining that the threshold rules database includes a threshold rules set for the product identifier, the apparatus 200 retrieves the threshold rules set for the product identifier from the threshold rules database and applies the threshold rules set as described herein.

According to some examples, the method includes initiating the performance of one or more monitoring devices associated with the load space embodying the at least one product at operation 608. In some embodiments, the one or more monitoring devices includes one or more sensors and/or components configured to measure one or more environmental condition parameters (e.g., temperature, pressure, tilt, altitude, humidity, etc.). In some embodiments, the apparatus 200 initiates the performance of the one or more monitoring devices in response to an indication. In some embodiments, the indication indicates the beginning of an event, for example, the start of the transportation of the at least one product from a starting location to a final destination. In some embodiments, the indication comprises a signal, a request, and/or the like. For example, in some embodiments, the indication is received in response to user input. As another example, in some embodiments, the indication is automatically received in response to the occurrence of an event. In some embodiments, initiating the one or more monitoring devices includes transmitting one or more signals to the one or more monitoring devices, where the one or more signals causes the one or more monitoring devices to begin capturing measurement data corresponding to the loading space comprising the at least one product. Additionally or alternatively, in some embodiments, initiating the one or more monitoring devices includes transmitting one or more control signals to a system embodying the one or more monitoring devices, where the noted system may cause the one or more monitoring devices to begin capturing measurement data corresponding to the loading space comprising the at least one product. In some embodiments, the one or more monitoring devices includes one or more sensors and/or components configured to measure one or more environmental conditions (e.g., temperature, pressure, tilt, altitude, humidity, etc.) of the load space comprising the product(s) being transported.

In some embodiments, the one or more monitoring devices whose operation is initiated by the monitoring system 102 comprises each monitoring device associated with the load space. For example, in some embodiments, the monitoring system 102 initiates the operation of all monitoring devices associated with the load space. In this regard, in some examples, the one or more monitoring devices may monitor a plurality of parameters, where at least one parameter of the plurality of parameters may not be included in the monitoring parameter(s) determined for the load space for the particular transportation.

In some embodiments, the one or more monitoring devices whose operation is initiated by the monitoring system 102 includes a subset of the monitoring device(s) associated with the load space comprising the product(s) to be monitored, where the subset includes monitoring devices configured to monitor environmental conditions parameters that correspond to monitoring parameters for the product(s) being monitored.

In some embodiments, each monitoring device of the one or more monitoring device(s) is configured to measure a particular environmental condition parameter of the load space. For example, in such some embodiments, a first monitoring device is configured to measure a first environmental condition parameter while a second monitoring device is configured to measure a second environmental condition parameter that is different from the first environmental condition parameter. In some examples, the monitoring parameter(s) for a particular product identifier includes a first parameter of a first sensor type associated and a second parameter of a second sensor type associated with a second product identifier.

In some embodiments, operation 608 is optional. For example, in some embodiments, the one or more monitoring devices may be configured to begin collecting monitoring data associated with the load space by other method(s) that does not include the apparatus 200 initiating the performance of the one or more monitoring devices. For example, the one or more monitoring devices may be configured to being collecting monitoring data associated with the load space in response to movement with respect to the load space. In some embodiments, initiating the performance of one or more monitoring devices associated with the load space refers to an event, wherein the apparatus 200 begins to receive the monitoring data from the one or more monitoring devices.

According to some examples, the method includes receiving monitoring data from the one or more monitoring devices at operation 610. As noted, in some embodiments, the one or more monitoring devices is configured to monitor the entirety of an environment (e.g., load space) within which the at least one product is included (e.g., housed) during transit. In some embodiments, the apparatus 200 periodically receives the measurement data. In some embodiments, the apparatus 200 to continuously receives the measurement data. In some embodiments, the monitoring data includes measured environmental condition parameter values, metadata, timestamp data, and/or other particular data parameters that are helpful to a system and/or user to determine threshold satisfaction of a threshold rules set associated with a product identifier. In some embodiments, the apparatus 200 stores the received monitoring data in a database, where the database may be accessed by the apparatus 200 and/or one or more components of the apparatus 200. In some embodiments, the apparatus 200 stores only a portion of the monitoring data received from the one or more monitoring devices. For example, where the monitoring system 102 initiates the operation of all monitoring devices associated with the load space, the apparatus 200 may store only a portion of the received monitoring data that correspond to the monitoring parameter(s) identified for the at least one product identifier, for example, the monitoring parameter(s) identified at operation 604. In this regard, in some embodiments, the apparatus 200 stores only a portion of the received monitoring data pertinent to the particular products and/or product types determined in the load space environment.

According to some examples, the method includes processing the monitoring data to determine satisfaction of each rule in the threshold rules set for the at least one product identifier at operation 612. In some embodiments, the apparatus 200 processes the monitoring data in real-time or near real-time to determine satisfaction of each rule in the set of one or more rules for the at least one product identifier. In some embodiments, processing the monitoring data includes applying the threshold rules set(s) to the monitoring data. In some embodiments, applying the threshold rules set to the monitoring data includes utilizing a model configured to determine threshold rule violation. The model may be configured to generate and outputs data indicating the results of a threshold rule violation determination. The results data in some embodiments, includes a data value for a particular monitoring parameter that indicates whether the threshold rule associated with the monitoring parameter was determined violated.

According to some examples, the method includes generating a notification in response to determining that the monitoring data associated with at least one product identifier fails to satisfy at least one rule of the rules set at operation 614. In some embodiments, the notification includes data indicating the package(s) and/or corresponding monitoring parameters violated.

According to some examples, the method includes transmitting the notification to a client device at operation 616. The client device in some embodiments may comprise a user computing device. In some embodiments, the client device may comprise the same client device from which the product identifier were received and/or other client device(s) (e.g., client device associated with the driver of the transportation vehicle, client device associated with a manger of the transportation company, client device associated with an owner of the package associated with the threshold violation, and/or the like).

### CONCLUSION

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for improved product monitoring during transit, the method comprising:
receiving at least one product identifier associated with at least one product;
determining, based at least in part on the at least one product identifier, at least one monitoring parameter;
determining a threshold rules set for the at least one product identifier based at least in part on the at least one monitoring parameter;
receiving monitoring data from one or more monitoring devices of a plurality of monitoring devices configured to monitor the condition of the entirety of an environment within which the at least on product associated with the at least one product identifier is included during transit;
processing the monitoring data to determine satisfaction of each rule in the threshold rules set for the at least on product identifier; and
storing at least a portion of the monitoring data corresponding to the at least one monitoring parameter.

2. The computer-implemented method of claim 1, wherein the at least one product identifier comprises a first product identifier associated with a first product and a second product identifier associated with a second product that is different for the first product.

3. The computer-implemented method of claim 1, wherein the at least one monitoring parameter comprises a first parameter of a first sensor type associated with a first product identifier and second parameter of a second sensor type associated with ta second product identifier.

4. The computer-implemented method of claim 1, wherein the at least one monitoring parameter comprises a first monitoring parameter of a first sensor type, wherein the first monitoring parameter is shared between a first product identifier and a second product identifier.

5. The computer-implemented method of claim 1, wherein the one or more monitoring devices comprise at least on IoT device.

6. The computer-implemented method of claim 1, wherein the at least one product identifier is received from an indicia reader configured to read the at least one product identifier from a machine readable symbology associated with the at least one product.

7. The computer-implemented method of claim 1, wherein the one or more monitoring devices (i) are configured to monitor environmental conditions corresponding to the at least one monitoring parameter, and (ii) comprise a subset of the plurality of monitoring devices.

8. The computer-implemented method of claim 1, further comprising:
initiating the operation of the one or more monitoring devices in response to an indication indicating the start of transportation of the at least one product from a starting location to an end location.

9. The computer-implemented method of claim 1, wherein the at least one monitoring parameter comprises one or more of real-time location, temperature, pressure, tilt, altitude, or humidity.

10. The computer-implemented method of claim 1, wherein determining the threshold rules set for the at least one product identifier comprises:
determining threshold data associated with the at least one monitoring parameter; and
applying a model to the threshold data to output the threshold rules set.

11. The computer-implemented method of claim 10, wherein the threshold data comprises one or more of minimum threshold value for the at least one monitoring parameter, maximum threshold value for the at least one monitoring parameter, or threshold violation duration for the at least one monitoring parameter.

12. The computer-implemented method of claim 1, wherein determining the at least one monitoring parameter comprises retrieving data comprising the at least one monitoring parameter from a master data library.

13. The computer-implemented method of claim 1, further comprising:
generating a notification in response to determining that the monitoring data fails to satisfy at least one rule of the threshold rules set.

14. An apparatus comprising at least one processor and at least one memory storing instructions that, when executed by the at least one processor, cause the apparatus to:
receive at least one product identifier associated with at least one product;
determine, based at least in part on the at least one product identifier, at least one monitoring parameter;
determine a threshold rules set for the at least one product identifier based at least in part on the at least one monitoring parameter;
receive monitoring data from one or more monitoring devices of a plurality of monitoring devices configured to monitor the condition of the entirety of an environment within which the at least on product associated with the at least one product identifier is included during transit;
process the monitoring data to determine satisfaction of each rule in the threshold rules set for the at least on product identifier; and
store at least a portion of the monitoring data corresponding to the at least one monitoring parameter.

15. The apparatus of claim 14, wherein the at least one product identifier comprises a first product identifier associated with a first product and a second product identifier associated with a second product that is different for the first product.

16. The apparatus of claim 14, wherein the at least one monitoring parameter comprises a first parameter of a first sensor type associated with a first product identifier and second parameter of a second sensor type associated with ta second product identifier.

17. The apparatus of claim 14, wherein the at least one monitoring parameter comprises a first monitoring parameter of a first sensor type, wherein the first monitoring parameter is shared between a first product identifier and a second product identifier.

18. The apparatus of claim 14, wherein the one or more monitoring devices comprise at least on IoT device.

19. The apparatus of claim 1, wherein the at least one product identifier is received from an indicia reader configured to read the at least one product identifier from a machine readable symbology associated with the at least one product.

20. A computer program product comprising at least one non-transitory computer-readable storage medium, the at least one non-transitory computer-readable storage medium including instructions that when executed by at least one processor, cause the computer to:
receive at least one product identifier associated with at least one product;
determine, based at least in part on the at least one product identifier, at least one monitoring parameter;
determine a threshold rules set for the at least one product identifier based at least in part on the at least one monitoring parameter;
receive monitoring data from one or more monitoring devices of a plurality of monitoring devices configured to monitor the condition of the entirety of an environment within which the at least on product associated with the at least one product identifier is included during transit;
process the monitoring data to determine satisfaction of each rule in the threshold rules set for the at least on product identifier; and
store at least a portion of the monitoring data corresponding to the at least one monitoring parameter.
